(19) United States
(12) Patent Application Publication
(10) Pub. No.: US 2007/0121341 A1
(43) Pub. Date: May 31, 2007

(54) BACKLIGHT DEVICE AND LIQUID CRYSTAL DISPLAY USING THE SAME

(75) Inventor: Ko Owada, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/562,600

(22) Filed: Nov. 22, 2006

(30) Foreign Application Priority Data
Nov. 28, 2005 (JP) 2005-342015

(51) Int. Cl. F21V 7/04

(52) U.S. Cl. 362/606; 362/607

(57) ABSTRACT

A backlight device is provided. The backlight device a light guiding member that guides light from a light source; and an optical element disposed on the light guiding member. An end portion of the optical element, which faces the light source, is farther from the light source than an end portion of the light guiding member facing the light source.

This patent document claims the benefit of Japanese Patent Application No. 2005-342015 filed on Nov. 28, 2005, which is hereby incorporated by reference.

### BACKGROUND

1. Field

The present embodiments relate to a backlight device and a liquid crystal display using the same.

2. Related Art

In a related art, a liquid crystal display generally includes a backlight structure composed of a light guiding plate which introduces light of a light source from an end portion onto a main surface, a diffusing plate formed on the main surface of the light guiding plate, and a reflecting plate formed on the main surface opposite to the light guiding plate (for example, see JP-A-10-161119). The liquid crystal display has a structure preventing a bright line or a hot spot from occurring on a display surface in the vicinity of a light source, such as a cathode tube or an LED (Light Emitting Diode).

As shown in FIG. 4, a band-shaped light absorbing layer 106 is formed on a surface facing a light source of at least one of a light guiding plate 102 in the vicinity of a light source 101, a diffusing plate 103, a prism plate 104 or a reflecting plate 105 A band-shaped light reflecting layer 107 is formed on at least one light absorbing layer 106.

The light reflecting layer 107 reflects light in the vicinity of the light source 101, which enters the light guiding plate 102 and is output toward the light absorbing layer 106, or toward the light guiding plate 102, thus deterring loss due to absorbing of light on the light absorbing layer 106. The light absorbing layer 106 absorbs light traveling from an end portion of the light guiding plate 102 to the liquid crystal display surface. The light reflecting layer 107 reflects the light.

When a liquid crystal display panel is relatively small in size, for example, a display panel in a cellular phone, it is impossible to sufficiently prevent occurrence of the bright line or the hot spot by the above-described method.

### SUMMARY

The present embodiments may obviate one or more of drawbacks inherent in the related art. For example, in one embodiment, a backlight device can reliably prevent occurrence of a bright line and a hot spot even in a relatively small liquid crystal display panel.

In one embodiment, a backlight device includes a light guiding member which guides light from a light source, and an optical element disposed on the light guiding member. An end portion of the optical element facing the light source is farther from the light source than an end portion of the light guiding member facing the light source.

In one embodiment, the end portion of the optical element facing the light source is distanced from the end portion of the light guiding member facing the light source. In this embodiment, it is possible to block light traveling from the light guiding plate toward the liquid crystal display panel in a region where the optical element does not exist. In this exemplary embodiment, it is also possible to reliably prevent occurrence of a bright line and a hot spot in a liquid crystal display using a relatively small liquid crystal display panel.

In one embodiment, the optical element may be composed of a plurality of optical elements, and an end portion of an upper optical element facing the light source may be farther from the light source than an end portion of a lower optical element facing the light source.

In one embodiment, the plurality of optical elements include a diffusing plate formed on the light guiding member. An end portion of the diffusing plate facing the light source is disposed substantially at the same position as the end portion of the light guiding plate facing the light source.

In one embodiment, the backlight device includes a frame body accommodating the light guiding member and the optical element. The optical element has a first positioning portion, and the frame body has a second positioning portion corresponding to the first positioning portion. In this embodiment, it is possible to easily mount the optical elements on the frame body.

In one embodiment, a liquid crystal display includes the above-described backlight device. The liquid crystal display panel is operatively disposed on the backlight device and introduces light from the backlight device and outputs the light to the outside.

### BRIEF DESCRIPTION OF THE DRAWINGS

FIG. 1 is a cross-sectional view showing one embodiment of a backlight structure of a liquid crystal display;

FIGS. 2A to 2F are views showing exemplary embodiment of optical elements mounted on a frame material of a liquid crystal display;

FIG. 3A is a view showing a display state of the liquid crystal display using a backlight device according to one embodiment;

FIG. 3B is a view showing a display state of the liquid crystal display using a backlight device according to the related art; and

FIG. 4 is a cross-sectional view showing the backlight structure of the liquid crystal display according to the related art.

### DETAILED DESCRIPTION

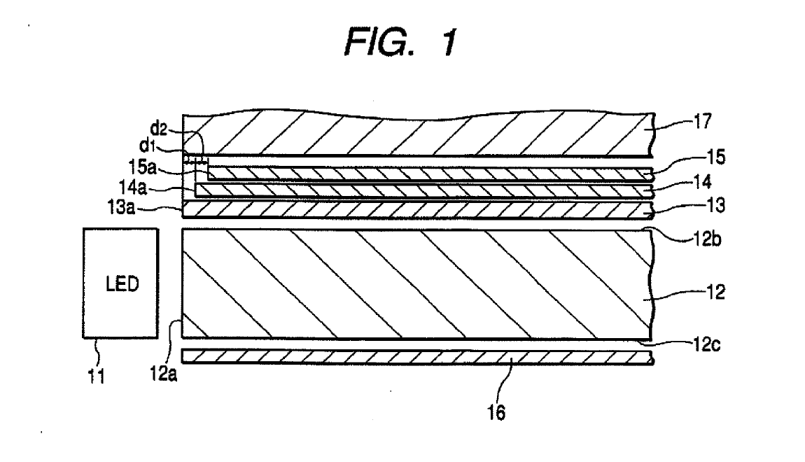

FIG. 1 is a cross-sectional view showing a liquid crystal display having a backlight device according to one embodiment. In one embodiment, as shown in FIG. 1, a backlight structure of the liquid crystal display includes a light source LED 11. A light guiding plate 12 is disposed adjacent to and in the vicinity of the LED 11. The light guiding plate 12 has a flat plate shape, and a side surface 12a thereof is made as a light incident surface and disposed to face the LED 11. On one main surface 12b of the light guiding plate 12, a diffusing plate 13 is disposed to diffuse light output from the light guiding plate 12. On the diffusing plate 13, a pair of prism plates 14 and 15, which diffuse light in different directions, is disposed. On the other main surface 12c of the light guiding plate 12, the reflecting plate 16 is disposed to reflect light output from the light guiding plate 12 back to the light guiding plate 12. A liquid crystal display panel 17 is disposed in the backlight device having the above-described construction. As shown in FIG. 1, the liquid crystal display panel 17 is disposed on the pair of prism plates 14 and 15.

In one embodiment, end portions 13a to 15a of the optical elements (here, the diffusing plate 13 and the prism plate 14), facing the LED 14, disposed on the light guiding plate 12 are farther from the LED 11 than an end portion of the light guiding plate 12 facing the LED 11.

In one embodiment, the end portion 13a of the diffusing plate 13 is disposed substantially at the same position as the end portion 12a of the light guiding plate 12. Therefore, the end portion 14a of the prism plate 14, for example, a lower layer (a layer that is closer to the light guiding plate) is d1 farther (receded) from the LED 11 than the end portion of the light guiding plate 12 facing the LED 11. The end portion 15a of the prism plate 15, for example, an upper layer (a layer that is farther from the light guiding plate) is d1+d2 farther from the LED 11 than the end portion of the light guiding plate 12 facing the LED 11. For example, the prism plate 15 is d2 farther from the LED 11 than the end portion of the lower prism plate 14 facing LED 11.

In one embodiment, the optical elements laminated on the light guiding plate 12 constitute a structure in which the end portion facing the LED 11 goes farther from (recedes from) the LED 11, as it goes to an upper layer. The d1 and d2 are preferably set in the range of about 0.5 mm to 2.0 mm, taking into consideration the occurrence of the bright line and the hot spot.

In one embodiment, the end portion facing the LED 11 of the optical elements disposed on the light guiding plate 12 is disposed so as to be farther from the LED 11 than the end portion (side surface 12a) facing the LED 11 of the light guiding plate 12. In this embodiment, it is possible to block light traveling from the light guiding plate 12 toward the liquid crystal display panel 17 in a region where the optical element does not exist. Accordingly, it is possible to reliably prevent occurrence of the bright line and the hot spot in a liquid crystal display using a relatively small liquid crystal display panel.

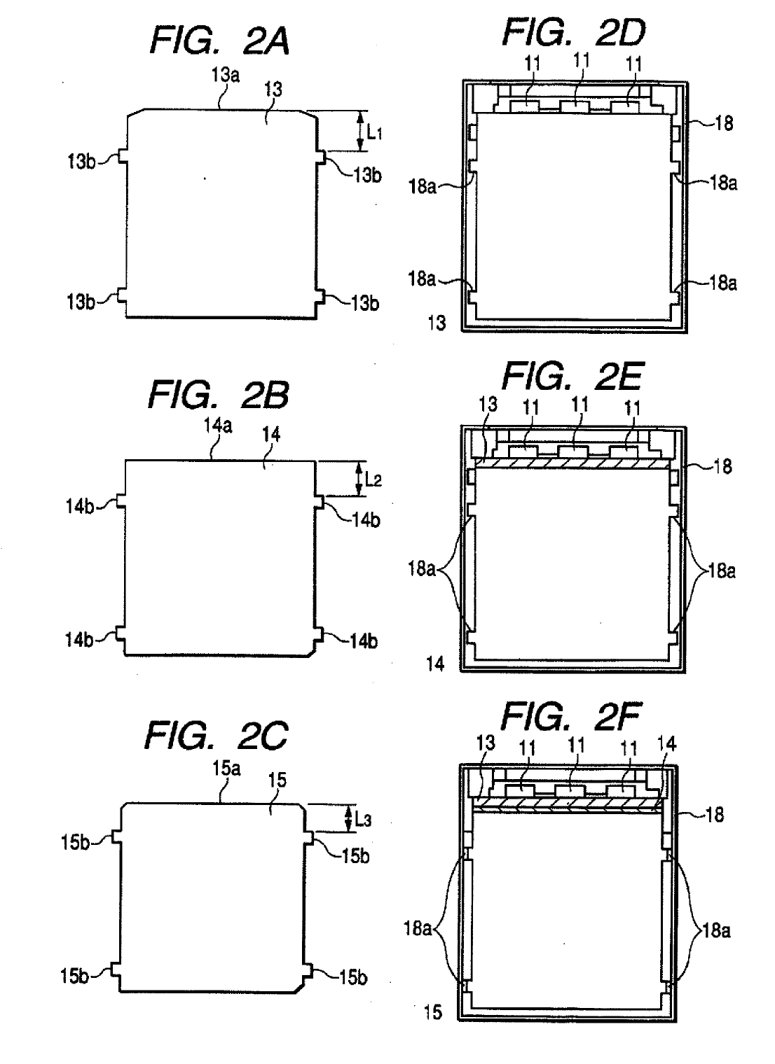

FIGS. 2A to 2F are views showing a state in which optical elements, for example, a diffusing plate 13 or prism plates 14 and 15, are mounted on a frame body 18 of a liquid crystal display.

With respect to the length (light in a vertical direction in the drawing) of the diffusing plate 13 shown in FIG. 2A, the prism plates 14 and 15 have a smaller length. For example, a distance L2 from the end portion 14a of the prism plate 14 (intermediate layer of the optical elements) disposed on the diffusing plate 13 on the light guiding plate 12 to a closest positioning protrusion 14b is smaller than a distance L1 from the end portion 13a of the diffusing plate 13 (lower layer of the optical elements) disposed on the light guiding plate 12 to a closest positioning protrusion 13b.

A distance L3 from the end portion 15a of the prism plate 15 (upper layer of the optical elements) disposed on the prism plate 14 on the light guiding plate 12 to a closest positioning protrusion 15b is smaller than the distance L2 from the end portion 14a of the prism plate 14 (intermediate layer of the optical elements) disposed on the diffusing plate 13 on the light guiding plate 12 to the closest positioning protrusion 14b. For example, the distance relationship may be indicated by L1>L2>L3. In the respective optical elements, distances between the protrusions are substantially equal.

In one embodiment, the liquid crystal display includes a frame body 18. In the frame body 18, positioning concave portions 18a are formed to correspond to the positioning protrusions 13b, 14b, and 15b, respectively. In the case of mounting the diffusing plate 13 on the frame body 18, as shown in FIG. 2D, the protrusion 13b is inserted into the concave portion 18a of the frame body 18 while the end portion 13a faces the LED 11.

In one embodiment, as shown in FIG. 2E, the prism plate 14 is mounted on the frame body 18. The protrusion 14b is inserted into the concave portion 18a of the frame body 18 while the end portion 14a faces the LED 11.

In one embodiment, as shown in FIG. 2F, the prism plate 15 is mounted on the frame body 18. The protrusion 15b is inserted into the concave portion 18a of the frame body 18 while the end portion 15a faces the LED 11. As positioning portions are formed in the optical elements and the frame body, respectively, the optical elements are mounted on the frame body using the positioning elements. In this embodiment, it becomes possible to easily mount the optical elements on the frame body 18 in an accurately positioned state.

In one embodiment, the distance from the end portion of the optical elements to the closest positioning protrusion differs according to the optical elements. In this embodiment, it is possible to prevent occurrence of an error of the optical element. In another embodiment, the direction of the optical elements can be recognized. In this embodiment, it is possible to prevent the optical elements from being mounted on the frame body 18 in a reversed direction.

In one embodiment, light from the LED 11 enters the side surface 12a of the light guiding plate 12 and propagates inside the light guiding plate 12. In this embodiment, the light output from the main surface 12c of the light guiding plate 12 is reflected by the reflecting plate 16 and returns to the light guiding plate 12. Light output from the main surface 12b of the light guiding plate 12 is diffused by the diffusing plate 13 serving as an optical element, polarized by the prism plates 14 and 15, and sent to the liquid crystal display panel 17.

The light sent to the liquid crystal display panel 17 is optically modulated and output to the outside. A user recognizes the light output to the outside.

In this embodiment, in the vicinity of the side surface 12a of the light guiding plate 12, the end portion of the optical element facing the LED is disposed father from the LED 11 than the end portion of the light guiding plate 12 facing the LED, so that light traveling from the end portion of the light guiding plate 12 toward the liquid crystal display panel 17 in a region where the optical element does not exist. Accordingly, it is possible to reliably prevent a bright line and a hot spot from occurring in the liquid crystal display using a relatively small liquid crystal display panel.

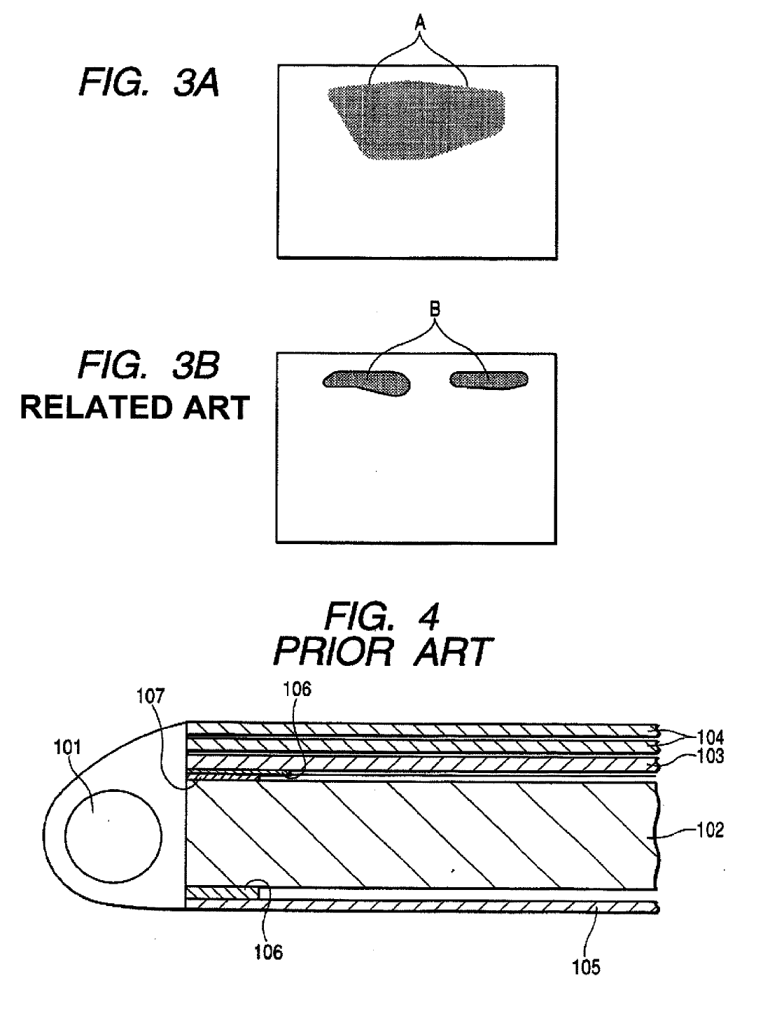

In the liquid crystal display having the construction of FIG. 1 when light of the backlight device is irradiated on the liquid crystal display panel the liquid crystal display produces results similar to those shown in FIG. 3A.

In the liquid crystal display having the construction of the FIG. 4, when light of the backlight device is irradiated on the liquid crystal display panel the liquid crystal display produces results similar to those shown in FIG. 3B. For example, the size of the liquid crystal display panel is about 1.3 inches.

As shown in FIG. 3A, in the liquid crystal display using the backlight device, the hot spot is deterred in the vicinity of the LED, and a region with high luminance spreads over a wide area (portion A in the drawing).

As shown in FIG. 3B, in the liquid crystal display using the backlight device according to the related art, the hot spot is partially found in the LED (portions B in the drawing).

On exemplary embodiment makes it possible to reliably prevent the bright line and the hot spot from occurring as well in the relatively small liquid crystal display panel.

The application of the invention is not limited to the above-described embodiment, and it can be modified in various forms. For example, according to one exemplary embodiment, the optical elements include the diffusing plate and the prism plate, but the invention is not limited to this exemplary embodiment. For example, an additional optical element may be included in the construction in which the end portion of the optical element facing the light source is farther from the light source than the end portion of the light guiding plate facing the light source. In addition, the number of layers of the optical elements are not limited.

According to one embodiment, two protrusions of the optical elements are formed on the side surfaces facing each other; however, the invention is not limited thereto, and the location and number of protrusions are not limited as long as the location and number of concave portions of the frame body correspond thereto.

According to another embodiment, the positioning portion of the optical element is the protrusion, and the positioning portion of the frame body is the concave portion. However, if the optical element is positioned with respect to the frame body, the positioning portion of the frame body is the protrusion, and the positioning portion of the optical element is the concave portion. The numerical value described in the embodiment is not limited to a specific value. In addition, it can be modified in various forms.

In one embodiment, the backlight device according to the invention can be used in electronic equipment having a relatively small liquid crystal display panel, for example, a mobile phone or a note book computer.

According to one embodiment, the backlight device includes a light guiding member which guides light from a light source, and an optical element disposed on the light guiding member. An end portion of the optical element facing the light source is farther from the light source than an end portion of the light guiding member facing the light source. Therefore, it is possible to reliably prevent the bright line and the hot spot from occurring in the liquid crystal display using the relatively small liquid crystal display panel.

Various embodiments described herein can be used alone or in combination with one another. For example, the invention can be one embodiment or a combination of embodiments. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A backlight device comprising:
a light guiding member that guides light from a light source; and
an optical element disposed on the light guiding member,
wherein an end portion of the optical element, which faces the light source, is farther from the light source than an end portion of the light guiding member facing the light source.

2. The backlight device according to claim 1,
wherein the optical element is composed of a plurality of optical elements, and
an end portion of an upper optical element, which faces the light source, is farther from the light source than an end portion of a lower optical element that faces the light source.

3. The backlight device according to claim 1,
wherein the optical element is composed of a plurality of optical elements,
the plurality of optical elements include a diffusing plate formed on the light guiding member, and
an end portion of the diffusing plate that faces the light source is disposed substantially at the same position as the end portion of the light guiding plate facing the light source.

4. The backlight device according to claim 1, further comprising:
a frame body that accommodates the light guiding member and the optical element,
wherein the optical element has a first positioning portion, and the frame body has a second positioning portion that faces to the first positioning portion.

5. The backlight device according to claim 1,
wherein the optical element is composed of a plurality of optical elements,
the plurality of optical elements each has a first positioning portion,
the frame body each has a second positioning portion corresponding to the first positioning portion,
the plurality of optical elements each has the first positioning portion at a different position, and
as each of the first positioning portions is inserted into one second positioning portion, positioning of the plurality of optical elements is controlled.

6. The backlight device according to claim 4,
wherein the first positioning portion is formed of a protrusion at the side of the optical element, and the second positioning portion is formed of a concave portion at an inner surface of the frame body.

7. The backlight device according to the claim 4,
wherein the first positioning portion is formed of a concave portion at the side of the optical element, and the second positioning portion is formed of a protrusion formed at an inner surface of the frame body.

8. A liquid crystal display comprising:
a backlight device that includes a light guiding member that guides light from a light source; and an optical element disposed on the light guiding member,
wherein an end portion of the optical element, which faces the light source, is farther from the light source than an end portion of the light guiding member facing the light source.

9. The liquid crystal display according to claim 8, comprising:
a liquid crystal display panel which is disposed on the backlight device and introduces light from the backlight device and outputs the light to the outside.

10. The backlight device according to claim 9,
wherein the optical element is composed of a plurality of optical elements, and
an end portion of an upper optical element, which faces the light source, is farther from the light source than an end portion of a lower optical element that faces the light source.

11. The backlight device according to claim 9,
wherein the optical element is composed of a plurality of optical elements,
the plurality of optical elements include a diffusing plate formed on the light guiding member, and
an end portion of the diffusing plate that faces the light source is disposed substantially at the same position as the end portion of the light guiding plate facing the light source.

12. The backlight device according to claim 9, further comprising:
a frame body that accommodates the light guiding member and the optical element,
wherein the optical element has a first positioning portion, and the frame body has a second positioning portion that faces to the first positioning portion.

13. The backlight device according to claim 9,
wherein the optical element is composed of a plurality of optical elements,
the plurality of optical elements each has a first positioning portion,
the frame body each has a second positioning portion corresponding to the first positioning portion,
the plurality of optical elements each has the first positioning portion at a different position, and
as each of the first positioning portions is inserted into one second positioning portion, positioning of the plurality of optical elements is controlled.

14. The backlight device according to claim 13,
wherein the first positioning portion is formed of a protrusion at the side of the optical element, and the second positioning portion is formed of a concave portion at an inner surface of the frame body.

15. The backlight device according to the claim 13,
wherein the first positioning portion is formed of a concave portion at the side of the optical element, and the second positioning portion is formed of a protrusion formed at an inner surface of the frame body.
